(19) United States
(12) Patent Application Publication
(10) Pub. No.: US 2015/0136822 A1
(43) Pub. Date: May 21, 2015

(54) Pet Ball Receptacle and Holder

(71) Applicant: Joanna Libertore, Denver, CO (US)

(72) Inventor: Joanna Libertore, Denver, CO (US)

(21) Appl. No.: 14/513,539

(22) Filed: Oct. 14, 2014

Related U.S. Application Data
(60) Provisional application No. 61/890,407, filed on Oct. 14, 2013.

(51) Int. Cl. A01K 27/00

(52) U.S. Cl. CPC A01K 27/008
USPC 224/242

(57) ABSTRACT

The preferred embodiment of the invention comprises a device that encapsulates and carries a pet toy, such as a ball, by means of a flexible structure with an opening able accept the toy. This device may also incorporate a constraining mechanism to ensure the retention of the pet toy. The device may also incorporate a fastening mechanism providing means to affix the device to a strap like object.

### CROSS-REFERENCE TO RELATED APPLICATION

This application claims the benefit of U.S. Provisional Application No. 61/890,407, filed Oct. 14, 2013.

### FIELD OF THE INVENTION

The present invention is in the field of consumer pet products.

### BACKGROUND OF THE INVENTION

When handling a pet, the presence of a toy, such as a ball, creates unsatisfactory situations for the owner. Such situations include the soiling of hands when a pet owner must carry a soiled toy after use. Such situations also include the incitement of a pet to become an overly excited pet when the toy is in plain view while being carried by the owner. Moreover, the carrying of pet toys can lead to the soiling of clothing articles when attempts are made to conceal the toy in a pocket or other article of clothing or accessory such as a purse.

After playing with toys, the saliva from the pet playing with the toy contaminates the toy. Moreover, dirt, excrement and other contaminants can affix themselves to the toy during the period in which the pet plays with the toy. Thus, due to the contamination of the toy, it becomes undesirable for a human to carry the toy after the pet has soiled the toy.

Many pet owners do not live with immediate access to open space large enough to engage in a game of fetch which spurs them to walk, drive or use alternative modes of transportation to travel to a local park or other open-space. As many pets, particularly dogs, enjoy this game with such fervor, the pet owner must use their discretion to keep the pet from over-exhaustion in the process of playing fetch. Furthermore, the pet owner may have to temper poor behavior in the pet as a result of the pet anticipating or immediately following a spirited game of fetch. These behavioral concerns are markedly more difficult to temper when the fetching-object is in plain sight of the pet. This poses a problem with hand carrying of the fetching-object due to concerns of both hygienic nature as well as eliciting poor behavior in the pet prior to or following a game of fetch.

Known pet toy carrying devices that enable a human to grasp a toy, however, generally lack a mechanism to allow a pet to carry the toy after the human retrieves it. Thus, although such prior art devices enable a human to retrieve a soiled toy without coming into contact with the soiled toy, the human generally must still carry the soiled toy by use of such a device. Thus, the human generally cannot use both hands for other tasks. Moreover, the human typically has an undesirable proximity to the soiled toy when carrying such a soiled toy with such a prior art device.

Other devices face difficulty accommodating commonly encountered dimensions of toys. For instance, other ball holders known in the prior art fail to securely contain a tennis ball if the tennis ball is new, or featuring a taut exterior. Likewise, some ball holders fail to securely contain a damaged or less inflated tennis ball.

Moreover, other holders known in the prior art lack a mechanism for easy extraction of the toy from the holder. Such prior art items feature continuous webbing that prevents easy access to or grip over balls. During the course of extraction in such prior art items, users regularly encounter difficulties associated with fingers becoming entangled in the continuous webbing. Other problems associated with such prior art holders relate to the difficulty in grasping the ball prior to extraction from the containment mechanism associated with such holders.

There is no presently available device that simultaneously solves the problems associated with a device carrying a soiled dog toy, ensuring retention of the toy and means to affix the device to a convenient object such as an article of clothing.

### SUMMARY OF THE INVENTION

In an apparatus embodying the principles of the invention provides a device to encapsulate and carry a pet toy, such as a ball, by means of a flexible structure with an opening able to accept the toy. This device may also incorporate a constraining mechanism to ensure the retention of the pet toy. The device may also incorporate a fastening mechanism providing means to affix the device to a convenient object.

In a preferred embodiment of the invention, the device incorporates a flexible mesh structure of durable nature with an elastic opening, to constrain the dog-toy within the mesh enclosure, and a clipping device to provide a means to affix the carrying device to the owner's waist-line, dog's collar or harness.

This invention allows the pet to transport a pet toy. This method enables the human to enjoy recreational activities with pets in a more sanitary manner. Further, the preferred embodiment of the invention enables a pet owner to keep the pet toy out of sight by clipping to the pet's collar or elsewhere in order to avoid over-exciting the pet.

### BRIEF DESCRIPTION OF THE DRAWINGS

FIG. 1. Three-quarters view of an embodiment of the invention.

FIG. 2A. Side view of an embodiment of the invention.

FIG. 2B Side view of a cross section of an embodiment of the invention with “Clip” not shown.

FIG. 3. A mechanism to secure the Containing Means to a Clip via a Clip Cap in an embodiment of the invention.

FIG. 4. A mechanism to secure the Containing Means to an Attachment Means via a locking pin and a Clip Cap in an embodiment of the invention.

FIG. 5A. An embodiment demonstrating how a User removes a toy from the Containing Means, with a pet owner's hand next to a fetching object within a Containing Means.

FIG. 5B. An embodiment demonstrating how a User removes a toy from the Containing Means, with a pet owner's hand grasping a fetching object through grasp grooves.

FIG. 5C. An embodiment demonstrating how a User removes a toy from the Containing Means, whereon a pet owner's hand has pulled out a fetching object from the Containing Means.

FIG. 6. A view of an embodiment of the invention whereby the Containing Means is clipped onto a dog collar of a dog via a Clip.

### DETAILED DESCRIPTION OF THE INVENTION

The present invention relates to an apparatus to enable a pet to carry its own toy.

Many pets 13 and pet owners alike enjoy a spirited game of “fetch.” The game of fetch involves the pet owner throwing a toy, such as a tennis-ball and allowing the pet to run and retrieve the toy. This process continues until the pet owner decides to terminate the activity, or the pet 13 no longer wishes to retrieve the toy by grasping the toy with the pet's mouth and running back to the pet owner. This game provides multiple benefits including exercise for the pet 13 and enjoyment for both pet 13 and pet-owner.

The action of the pet retrieving the toy by way of grasping it in their mouths introduces the toy to deposits of pet-saliva on the surface of the toy. The deposits of saliva can also provide adhesion of particulates from the ground surface to the surface of the toy. This can create a slimy, dirty and often unhygienic surface that interfaces with the hands of the pet-owner for an extended period of time if the pet-owner must carry the object while walking the pet to another location, a situation unappreciated by most individuals tasked with throwing such an object. Thus, the preferred embodiment of the present invention provides a mechanism by which the pet 13 can carry the toy.

Following a spirited game of fetch, the pet owner is often left with a soiled, soggy and slobbered pet toy to subsequently carry. Many pet owners find this exceedingly unpleasant as it is not only often perceived as disgusting, but is also unhygienic, ranging from discomfort to potentially dangerous for those with compromised immune systems. The preferred embodiment of this invention incorporates a Containing Means 1 that fully encapsulates the toy to eliminate the need for a pet owner to carry a soiled toy. The preferred embodiment of the invention incorporates an attachment means 3 to attach the entire apparatus to the collar or harness 13 of a pet near the neck area of the pet, outside of the pet's line of vision. An embodiment of the Containing Means 1 also employs the use of anti-microbial coatings to combat microorganisms. Another embodiment incorporates the use of fabric covering, for instance a sleeve, over the Containing Means 1.

Playing fetch requires no specific form or size requirements for the toy other than the provision of a size that is readily grasped in a pet owner's hand 11 and pet's mouth alike and of weight that can be thrown by the pet owner or grasped by means of the mouth of the pet. It will be easily recognized that alternative embodiments of the Containing Means 1 can be adapted to accommodate various sizes of balls or pet toys. While embodiments of the Containing Means 1 may be adapted to accommodate toys of varying shape and size, the inventor has recognized that the generally preferred toy for playing fetch with a pet is a tennis ball.

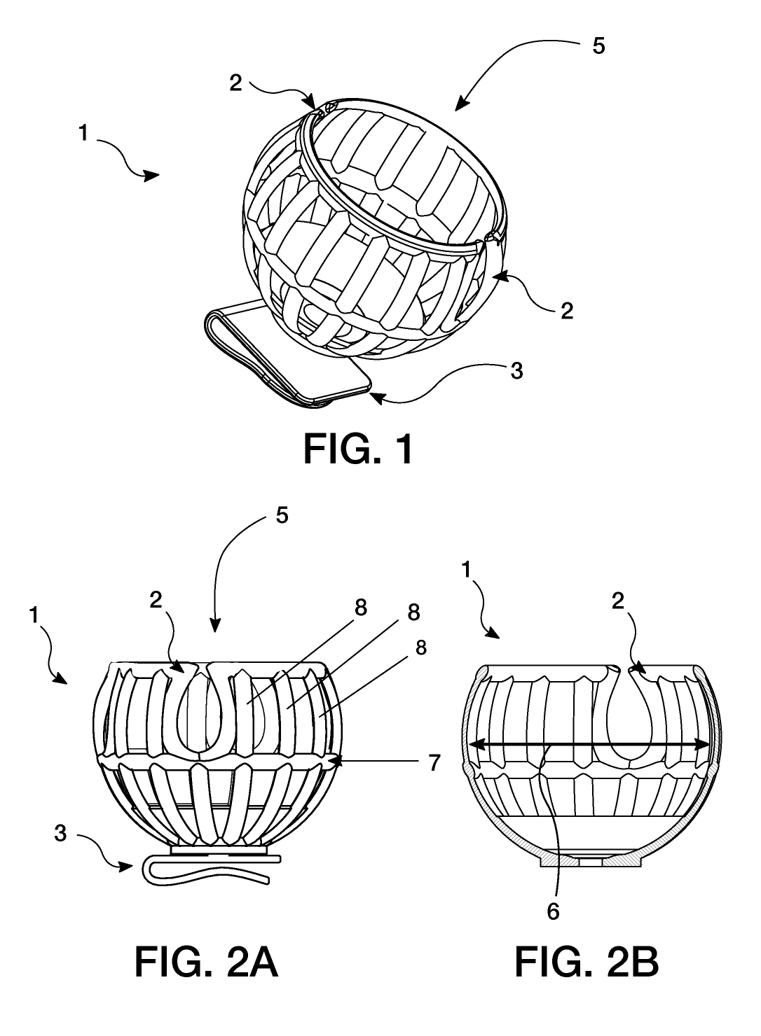

An embodiment of the invention, illustrated in FIG. 1, therefore provides a Containing Means 1 specifically for the containment and constraint of a tennis ball. The materials and design used in the Containing Means 1 in the preferred embodiment of the invention enable the Containing Means 1 to specifically accommodate new tennis balls featuring a taut exterior, and also old, damaged tennis balls that have deflated and do not have a taut exterior. Tennis balls are the preferred fetching object 10 for many pet owners given the ease of throwing and conformation to the size of mouth aperture characteristic of the typical pet engaged in a game of fetch. Furthermore a tennis ball provides an inexpensive, readily available fetching object that is unlikely to cause harm to the pet's mouth nor the pet's body, other animals, people or other inanimate objects which the fetching object may inadvertently strike during a game of fetch.

Standard sizes of fetching objects 10, which embodiments of the Containing Means 1 may carry in varying embodiments generally range from 1.5″ to 4″ in diameter for spherical objects and any non-spherical object, for instance an elongated cylindrical object or stuffed toy mimicking an animal such as a duck, exhibiting a dimension of 0.5″ to 4″ wide.

As illustrated in FIG. 2A, the preferred embodiment of the invention features a Containing Means 1 with dimensions designed to grasp and hold a tennis ball. In the preferred embodiment, the top opening 5 measures 2.22″ in diameter in the preferred embodiment. The cavity, at its widest point 6, measures 2.63″ in diameter in the preferred embodiment, as illustrated in a side view of the cross section of an embodiment of the invention in FIG. 2B. The webbing surrounding the cavity of the preferred embodiment features one support ring 7 with intersecting vertical bars 8.

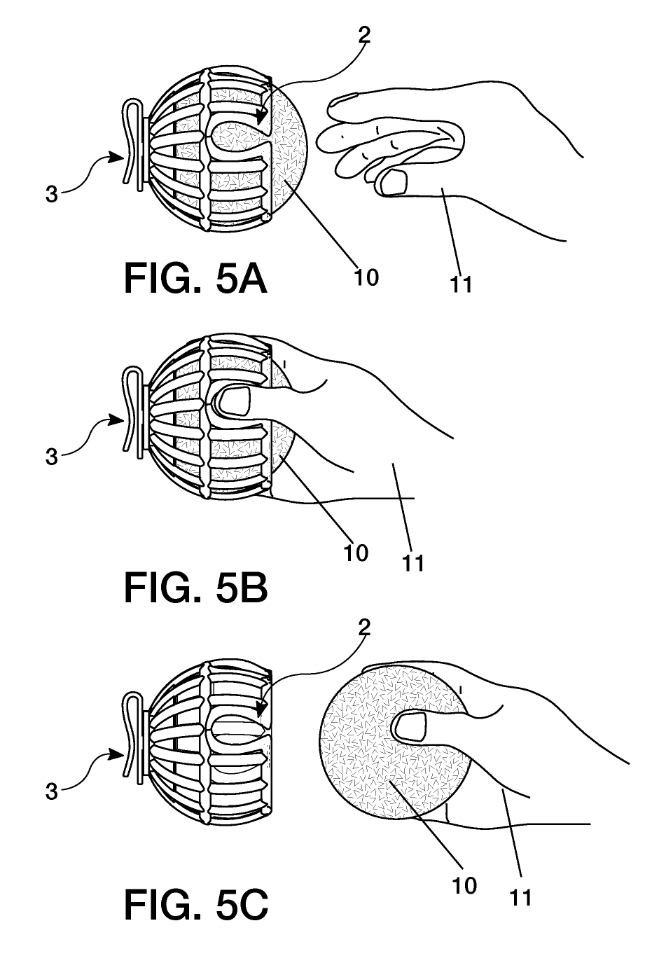

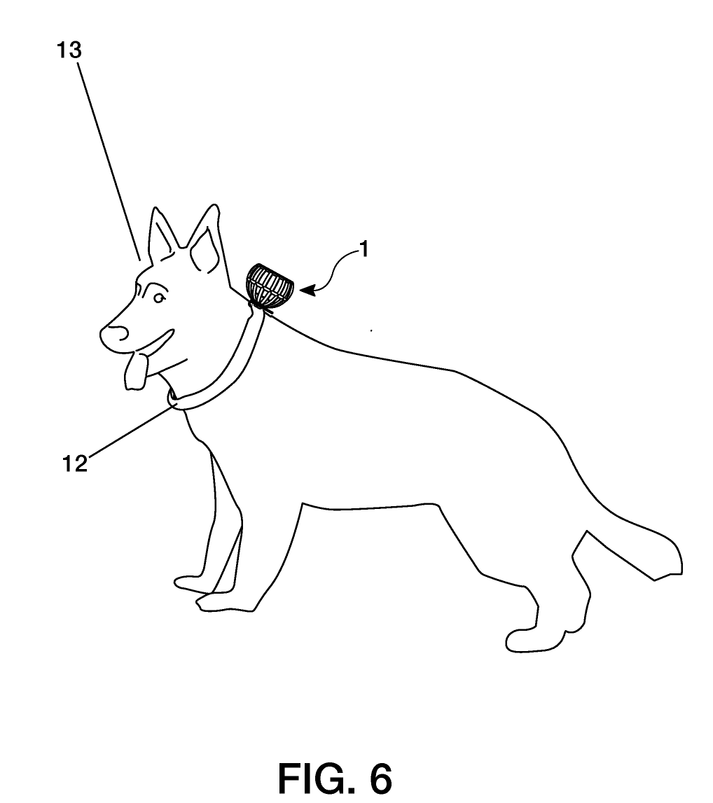

The preferred embodiment features a flexible and light-weight Containing Means 1 comprised of a flexible mesh webbing capable of providing constraint to a toy and also providing a hygienic buffer when transporting the toy. Furthermore, the preferred embodiment features an attachment means 3 comprised of a rigid yet flexible clip mechanism 3 to affix the preferred embodiment to a convenient article, such as for example a dog collar 12. The user, places the fetching object within said Containing Means 1 and constrains said fetching object within the top opening 5 which features a smaller diameter than the cavity at its widest point 6. To enable pet carrying, in the preferred embodiment, the user affixes the device to the collar 12 or harness of the pet, as illustrated in FIG. 6. As illustrated in FIG. 5A, the pet-owner may obtain the toy from the Containing Means 1, by grasping the toy through the grasp groove 2 as illustrated in FIG. 5B, and pulling the toy out of the cavity through the top opening 5 as illustrated in FIG. 5C, by which process the top opening 5 is dilated, enabling the removal of the toy without necessitating the detachment of the preferred embodiment of the invention from the pet's collar. In an embodiment of the invention, the grasp groove 2 enables the dilation of the top opening 5 by facilitating the separation of the two hemispheres of the diameter of the top opening 5.

The webbing may comprise a variety of materials in various embodiments. In the preferred embodiment of the Containing Means 1 material features a durometer of Shore 60-80 on the OO Scale. In the preferred embodiment, the webbing comprises silicon rubber netting, which the inventor notes has the added benefit associated with the ease of cleaning of the webbing.

Alternative embodiments of the invention provide a flexible and light-weight Containing Means 1 comprised of flexible textiles, woven metallic mesh, solid fabric organic or inorganic or semi-rigid structure to hold, constrain and provide hygienic buffer when transporting the fetching object. Other embodiments feature a Containing Means comprised of a rigid yet flexible material comprised of metal, plastic or composite to provide fetching-object retention for fetching objects of spherical or standard size such as a tennis ball or other commercially available fetching-objects such as bird-hunting training toys exhibiting an elongated cylindrical object with length over 4″ but with a 2″ diameter.

Furthermore, alternative embodiments of the invention may provide attachment means 3 comprised of a rigid yet flexible metal or plastic clip mechanism, hook-and-loop provisions, button-snap or other attaching strategy to affix said preferred embodiment to a convenient article comprising of a dog collar, leash, harness, article of clothing readily accessible to the pet-owner. In alternative embodiments, the Containing Means 1 may be permanently attached to a pet collar by an attachment means other than a clip, for instance comprising sewing the Containing Means 1 directly on to the pet collar or harness or gluing the Containing Means 1 on to the pet collar or harness.

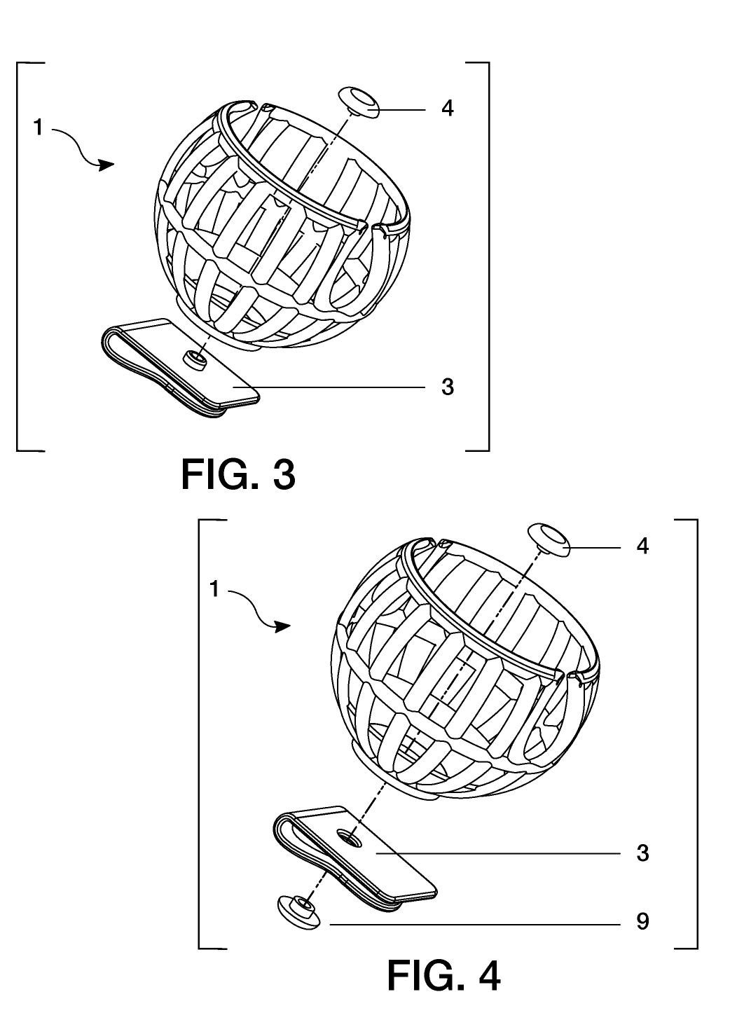

As illustrated in FIG. 3, in the preferred embodiment, the Containing Means 1 connects to a clip 3 designed to attach to a pet collar 12, harness or other strap-like apparatus. In the preferred embodiment, a protrusion extends from the clip 3 through a hole in the Containing Means 1, which is secured in place with a Clip Cap 4 connected to the protrusion in the cavity of the portion of the preferred embodiment featuring the webbing. In another embodiment of the invention, as illustrated in FIG. 4, the Containing Means 1 is secured to an Attachment Means 3 via a locking pin 9 and a Clip Cap 4.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued. Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The terms “coupled” and “linked” as used herein is defined as connected, although not necessarily directly and not necessarily mechanically. A device or structure that is “configured” in a certain way is configured in at least that way, but may also be configured in ways that are not listed. Also, the sequence of steps in a flow diagram or elements in the claims, even when preceded by a letter does not imply or require that sequence.

1. An apparatus, comprising:
a pet toy Containing Means, and
an attachment means.

2. The apparatus of claim 1, in which the pet toy Containing Means incorporates a grasp groove.

3. The apparatus of claim 1, in which the pet toy Containing Means comprises a material having a durometer of no less than Shore 60 and no more than Shore 80 on the OO scale.

4. The apparatus of claim 1, in which the pet toy Containing Means comprises silicon rubber.

5. The apparatus of claim 1, in which the attachment means comprises a clip.

6. The apparatus of claim 1, in which the attachment means comprises a clip attached to a containment means by a Clip Cap.

7. A pet toy holding device, comprising:
a pet toy Containing Means incorporating a grasp groove, comprising a material with a Shore durometer of no less than 60 and no more than 80, and
a clip attaching the Containing Means to a pet collar, said clip attached to the Containing Means by a Clip Cap.
